(19) United States
(12) Patent Application Publication
(10) Pub. No.: US 2008/0170033 A1
(43) Pub. Date: Jul. 17, 2008

(54) VIRTUAL POINTER

(75) Inventor: Mark D. Schultz, Ossining, NY (US)

Correspondence Address: FLEIT, KAIN, GIBBONS, GUTMAN, BONGINI & BIANCO PL, 551 NW 77TH STREET,, SUITE 111, BOCA RATON, FL, 33487, US

(73) Assignee: INTERNATIONAL BUSINESS MACHINES CORPORATION, ARMONK, NY (US)

(21) Appl. No.: 11/623,216

(22) Filed: Jan. 15, 2007

(51) Int. Cl. G06F 3/033

(52) U.S. Cl. 345/157

(57) ABSTRACT

A method, system, and device are provided for displaying a graphical pointer at a location on a display area. The method includes displaying, with an information processing system, a display image at a display area. The pointing device captures an image corresponding to at least a portion of the display image at the display area in a field of view of the pointing device. A location within the display image corresponding to a location in the at least the portion of the display image in the field of view of the pointing device is determined. Optionally, a virtual pointer is caused to be displayed at the determined location within the display image.

### FIELD OF THE INVENTION

The present invention generally relates to the field of pointing devices, and more particularly relates to a pointing device communicatively coupled to an information processing system for displaying a virtual pointer on an image.

### BACKGROUND OF THE INVENTION

Pointing devices such as laser pointers are often used to point to a particular portion/area of a displayed image. For example, a presenter may use a laser pointer during a presentation to direct the audience's attention to specific text or graphics on a display or projection screen. However, the use of a laser pointer has various drawbacks. For example, if the color of the laser is substantially the same color as the text and/or the graphic being pointed to the pointer (e.g., a colored dot) created by the laser pointer may not be seen by the presenter and/or audience. Also, if the intensity of the laser beam created by the laser pointer is at substantially the same intensity as the brightness of the pointed to text/and or image, the pointer (e.g. a colored dot) created by the laser pointer may not be seen by the presenter and/or audience.

Another pointing device available today is similar to a laser pointer, but uses infrared (“IR”) beams instead of a visible beam. A fixed camera, which is not attached to the pointing device is positioned at a given distance from a display or projection screen and calibrated. When the pointing device emits the IR beam on the display, the fixed camera detects the IR beam and transmits this information to a computer The computer then displays a pointer on the screen corresponding to the where the pointer is pointing to. One disadvantage of this type of pointer is the use of a fixed camera. The presenter is required to setup and calibrate the camera and transport the camera from place to place.

Therefore a need exists to overcome the problems with the prior art as discussed above.

### SUMMARY OF THE INVENTION

Briefly, in accordance with the present invention, disclosed are a method, system, and device for displaying a graphical pointer at a location on a display area. The method includes displaying, with an information processing system, a display image at a display area. The pointing device captures an image corresponding to at least a portion of the display image at the display area in a field of view of the pointing device. A location within the display image corresponding to a location in the at least the portion of the display image in the field of view of the pointing device is determined.

In accordance with another embodiment of the present invention, a method, with a pointing device, is provided for displaying a graphical pointer at a location on a display area. The method includes capturing an image corresponding to at least a portion of a displayed image at a display area in a field of view of the pointing device. The captured image is analyzed and based on the analyzing, a location in the captured image corresponding to a location in the displayed image at the display area is identified. Information associated with the identified location to an information processing system that is causing the displayed image to be displayed at the display area is transmitted.

According to another embodiment, a display pointing system is provided comprising an information processing system and a display. The display is communicatively coupled with the information processing system operable for displaying a display image at a display area of the display. A pointing device that is communicatively coupled with the information processing system captures, an image corresponding to at least a portion of the display image at the display area in a field of view of the pointing device. The information processing system is also operable for determining a location within the display image corresponding to a location in the at least the portion of the display image in the field of view of the pointing device.

In yet another embodiment, a display device is disclosed. The display device includes a processor and a means that is communicatively coupled with the processor. The means captures an image corresponding to at least a portion of a displayed image at a display area in a field of view of the pointing device. A transmitter that is communicatively coupled with the processor transmits information to an information processing system that is causing the displayed image to be displayed at the display area. The processor further analyzes the captured image and identifies, based on the analyzing, a location in the captured image corresponding to a location in the displayed image at the display area. The transmitter also transmits information associated with the identified location to the information processing system that is causing the displayed image to be displayed at the display area.

One advantage of an embodiment of the present invention is that a pointing device incorporates a camera for determining a location on a displayed image that the device is pointing to. The camera within the pointing device tracks where the pointing device is being pointed to and in one embodiment transmits information associated with its pointed-to-location to an information processing system. The information processing system can graphically display a virtual pointer at the pointer's pointed-to-location on the displayed image.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a system diagram illustrating an exemplary system according to an embodiment of the present invention;

FIG. 2 is a block diagram illustrating a more detailed view of a pointing device according to an embodiment of the present invention;

FIG. 3 is a block diagram illustrating a more detailed view of a pointing device transceiver base according to an embodiment of the present invention;

FIG. 4 is a block diagram illustrating a more detailed view of an information processing system according to an embodiment of the present invention;

FIG. 5 illustrates a virtual pointer being illustrated on a display corresponding to a pointed-to-location of a pointing device according to an embodiment of the present invention;

FIG. 6 illustrates the pointing device of FIG. 5 pointing to a new location on the display and the corresponding image captured by the pointing device according to an embodiment of the present invention;

FIG. 7 illustrates a virtual pointer being placed at initial position within the field of view of the pointing device of FIG. 6 according to an embodiment of the present invention;

FIG. 8 illustrates the location of the virtual pointer of FIG. 7 being placed at a position on the display that is substantially in the center of the field of view of the pointing device according to an embodiment of the present invention; and

FIG. 9 is an operational flow diagram illustrating an exemplary process of displaying a virtual pointer at a location in a displayed image corresponding to a pointing device's current pointed to location according to an embodiment of the present invention.

### DETAILED DESCRIPTION

The present invention as would be known to one of ordinary skill in the art could be produced in hardware or software, or in a combination of hardware and software. However in one embodiment the invention is implemented in software. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiment, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium, which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network that allows a computer to read such computer readable information. The present invention, according to an embodiment, overcomes problems with the prior art by providing a pointing device with an integrated camera for determining the pointed-to-location of the device. The pointing device is in communication with an information processing system that displays a virtual pointer at the determined pointed-to-location of the pointing device.

Exemplary System

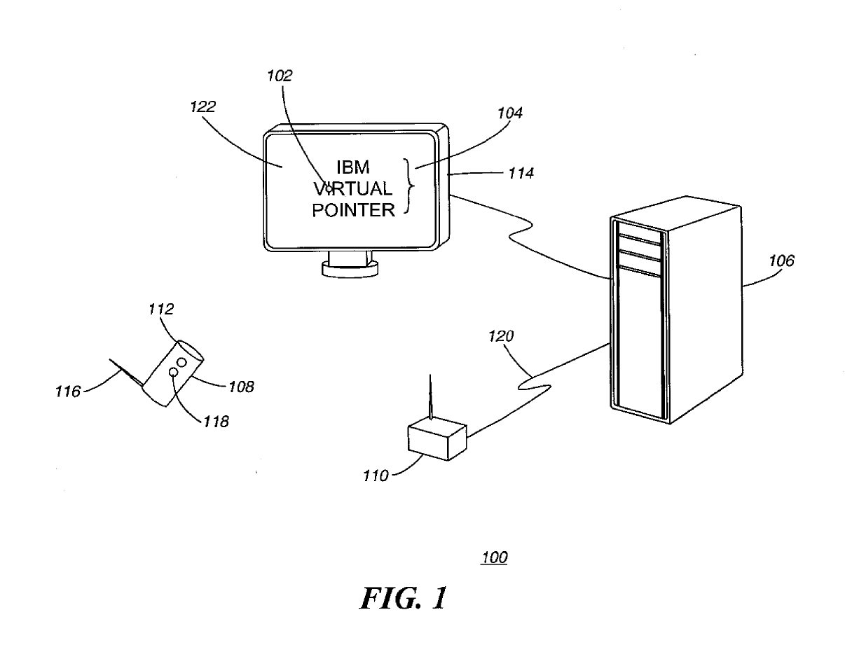

According to an embodiment of the present invention, as shown in FIG. 1, an exemplary system 100 operates for displaying a virtual pointer/pointing graphic 102 on a displayed image 104. In one embodiment, the system 100 includes one or more information processing systems 106, a pointing device 108, an optional pointing device transceiver base 110, and a display 114.

In one embodiment, the pointing device 108 comprises a camera 112 for capturing image frames corresponding to an area which includes all or part of displayed image 104 that the pointing device 108 is pointing toward. The specific pointed to point within the displayed image 104 would in one embodiment be the portion of the displayed image 104 that was imaged onto the central pixel or subset of pixels of the receiving camera 112. The pointing device 108, in one embodiment, also comprises an antenna 116 and one or more buttons 118. The antenna 116 allows for the transmission and reception of wireless data. For example, the pointing device 108 in one embodiment, can transmit information such as the captured image frames, a pointed-to-location identifier, information related to the captured image, and the like to the information processing system 106. In one embodiment, the pointing device 108 communicates with the information processing system 106 through an external transceiver base 110. The transceiver base 110 can be connected to the information processing system 106 through a connection interface 120 such as a Universal Serial Bus connection (“USB”), IEEE 1394 connection, and the like. In another embodiment, the transceiver base 110 is a wireless communication adapter situated within the information processing system 106.

The pointing device 108, in one embodiment, communicates with the transceiver base 110 using any wireless communication standard. For example, the pointing device 108 can be a Bluetooth device or use a wireless communication standard for high speed data transfer. In another embodiment, the pointing device 108 can communicate with the information processing system 106 and/or the transceiver base 110 through a wireless network (not shown). For example, the pointing device 108 can include a wireless network adapter. In another embodiment, the pointing device 108 is directly connected to the information processing system 106 via a wired connection (not shown). The wired connection (not shown) allows the pointing device 108 to communicate with the information processing system over a USB connection, an IEEE 1394 connection, and the like.

The buttons 118 residing on the pointing device can be used to display the pointing graphic and/or select items in the displayed image 104 similar to the function of buttons on a mouse or trackball. For example, a user can hold down one of the buttons 118 to have the pointing graphic 102 displayed on the generated image 104 while the button 118 is held down. In another embodiment, the button 118 performs a function similar to a toggle switch so that when the button 118 is pressed the pointing graphic 102 is displayed until the button 118 is pressed again. If the pointing graphic 102 is located on an item such as a clickable widget, the buttons 118 can be used to click on the widget. It should be noted the number of buttons 118 and the functions of the buttons 118 are not limited by the above discussion.

The information processing system 106, in one embodiment, generates an image 104 and displays that image on a display area 122 of a display 114. The display 114, in one embodiment, can be a cathode ray tube display, liquid crystal display, a plasma display, and the like. In another embodiment, the information processing system 106 is communicatively coupled to a projector (not shown) that projects the generated image 104 onto a surface such as a projection screen, a wall, and the like. The information processing system 106, in one embodiment, receives information associated with a captured image from the pointing device 108. The received information, in one embodiment, can be the entire captured image, coordinates of where the pointing device is pointing to within the displayed image 104, and the like.

In one embodiment, the pointing device 108 can process the captured image and transmit the results to the information processing system 106. In another embodiment, the pointing device 108 can transmit the entire captured image so that the information processing system 106 can process the captured image for determining where the pointing device 108 is pointing to within the displayed image 104. Alternatively, the pointing device 108 can transmit a portion or the entire captured image to the transceiver base 110. The transceiver base 110 can then process the received information to determine where the pointing device 108 is pointing to. The result can be communicated to the information processing system 106

Based on the information received from the pointing device 108 and/or the transceiver base 110, the information processing system 106 displays the pointing graphic 102 at a location on the displayed image 104 that corresponds to the location within the displayed image 104 being pointed to by the pointing device 108. For example, a user can give a presentation using the information processing system 106 to display a generated image 104 such as a presentation slide. As the user points the pointing device 108 at a particular area of the displayed image 104 the camera 112 in the pointing device 108 captures the pointed-to-area. This captured image is can be processed by the pointing device 108, the transceiver base 110, or the information processing system 108 to determine where within the displayed image 104 the pointing device 108 is aimed at. The information processing system 106 then displays a virtual pointed 102 at the pointed-to-location in the displayed image 104.

A display pointing device, according to an embodiment, includes a processor; and image capturing means, communicatively coupled with the processor, operable for capturing an image corresponding to at least a portion of a displayed image at a display area in a field of view of the pointing device, and a transmitter, communicatively coupled with the processor, operable for transmitting information to an information processing system that is causing the displayed image to be displayed at the display area. The processor, in this example, is operable for analyzing the captured image, identifying, based on the analyzing, a location in the captured image corresponding to a location in the displayed image at the display area, and transmitting, with the transmitter, information associated with the identified location to the information processing system that is causing the displayed image to be displayed at the display area.

In an alternative embodiment, a virtual pointer is not displayed in the displayed image 104, but instead, the determined pointed-to-location of the pointing device 108 is used for allowing a user to interact with the displayed image 104. For example, the information processing system 106, in one embodiment, displays a multimedia video game on the display 114. In this example, the pointing device 108 can be used for one or more functions in the multi-media video game such as aiming, controlling movement, and the like.

In another embodiment, the information processing system 106 does not generate the image 104 that is displayed on the display 114. In other words, the information processing system accepts an image(s) and displays it on the display 114. For example, an external component (not shown) such as a DVD player, gaming console, or any other device capable of generating and outputting video and/or still images can be connected to the information processing system 106. The information processing system 106 receives the video and/or images and displays them on the display 114. In another embodiment, an external component (not shown) is connected to the transceiver base 110. In this example, the information processing system is not used, but instead, the transceiver base 110 communicates with the external component (not shown) and the pointing device 108. The external component (not shown) can be connected to the display 114 or a projector (not shown) and the transceiver base 110 communicates with the pointing device 108 to determine a pointed-to-location in the displayed image 104.

The transceiver base 110 communicates this information to the external component (not shown), which then can either display a virtual pointer 102 on the image or perform a function such as aiming, controlling movement and the like based on this information. In another embodiment, the pointing device 108 performs all of the location determining and transmits this information to the external component (not shown) via a receiver (not shown).

Exemplary Pointing Device

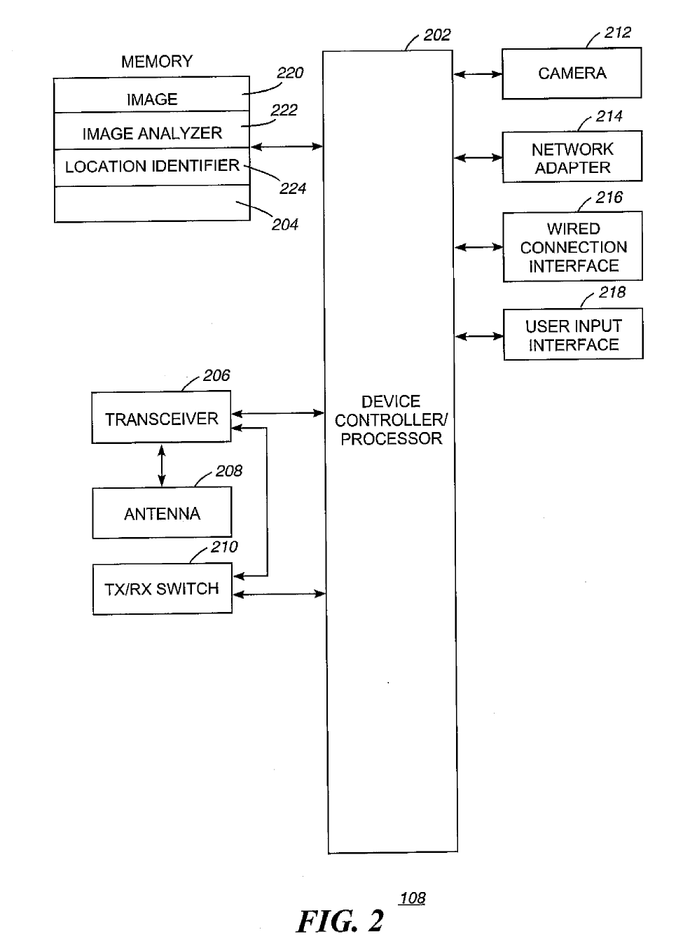

FIG. 2 is a block diagram illustrating a more detailed view of the pointing device 108 according to the present invention. The pointing device 108, in one embodiment, operates under the control of a device controller/processor 202. In one embodiment, a memory 204, a transceiver 206, an antenna 208, and transmit/receive switch 210, a camera 212, a user input interface 214, an optional network adapter 216, and an optional wired connection interface 216 are communicatively coupled to the device controller/processor 202. The pointing device 108, in one embodiment, also includes user input interfaces 218 such as buttons 118, a scroll wheel, and the like.

The pointing device 108 can wirelessly transmit and receive data via the transceiver 206. For example, the pointing device 108, in one embodiment, transmits a captured image, information related to a captured image, pointed-to-location information, and the like to another device such as the information processing system 106. The pointing device 108 receives information such as information associated with a virtual pointer 102 (e.g., type, size, color, and the like), displayed image information, and the like from a device such as the information processing system 106. It should be noted that the pointing device 108 is not limited to receiving information from the information processing system 106. For example the transceiver base 110 or another component such as a game console can also transmit information to the pointing device 108

In a receive mode, the device controller 202 electrically couples an antenna 208 through the transmit/receive switch 210 to a transceiver 206. In another embodiment, the pointing device 108 includes a separate receiver and transmitter. The transceiver 206 decodes the received signals and provides those decoded signals to the device controller 202. In a transmit mode, the device controller 202 electrically couples the antenna 208, through the transmit/receive switch, to the transceiver 206. The device controller 202, in one embodiment, operates the transceiver 206 according to instructions (not shown) in the memory 204.

The memory 204, in one embodiment, can be non-volatile memory and/or volatile memory such as RAM, cache, and the like. In one embodiment, the memory 204 includes one or more image frames 220 that have been captured by the camera 212. For example, as the pointing device 108 is pointed at a display area 122, the camera 212 captures an image frame 220 corresponding to at least a portion of a displayed image 104 in the display area 122 that is in a field of view of the camera 212. The captured image frame 220 can correspond to the entire displayed image 104 or a portion of the displayed image 104. The memory 204, in one embodiment, also includes an image analyzer 222 for analyzing the captured image frame(s) 220. For example, the captured image frame 220 is analyzed by the pointing device 108 so that a location identifier 224 can determine where in the displayed image 104 the pointing device 108 is pointing to. The results of this determination, e.g., the identified pointed-to-location, can then be transmitted to the information processing system 106 that is causing the displayed image 104 to appear in the display area 122.

In another embodiment, the image analyzer 222 detects reference points or indices within the captured image frame that allows the location identifier 224 to determine where the pointing device 108 is pointing to. In one embodiment, the indices can be toggled at high frequencies by the information processing system 106 to make them more detectable by the camera 212. In another embodiment, the indices/reference points can be laid out in the displayed image 104 as a matrix. It should be noted that the image analyzer 222 and the location identifier 224 are optional. The pointing device 108, in one embodiment, can transmit the entire captured image frame(s) 220 to the information processing system 106 and/or the transceiver base 110 so that these components can process the captured image frame(s) 220 to determine where the pointing device 108 is pointing to.

The pointing device 108, in one embodiment, can also receive information related to the virtual pointer 102. For example, the size, shape, color, etc. of the virtual pointer 102 can be communicated to the pointing device 108 by the information processing system 106. As the camera 212 captures an image frame 220 including the virtual pointer 102, the pointing device 108 can transmit this image 220 to the information processing system 106. The information processing system can then determine, based on the virtual pointer 102 and another point in the captured image 220, the position in the displayed image 104 that the pointing device 108 is pointing at. Alternatively, the pointing device 108 can perform this processing and transmit the results to the information processing system 106. Additionally, the pointing device 108 can also determine if the virtual pointer is located at a center pixel or central set of pixels in the field of view of the camera 212. If the virtual pointer 102 needs to be adjusted, the pointing device 108 can communicate the adjustment information to the information processing system 106.

Exemplary Pointing Device Base

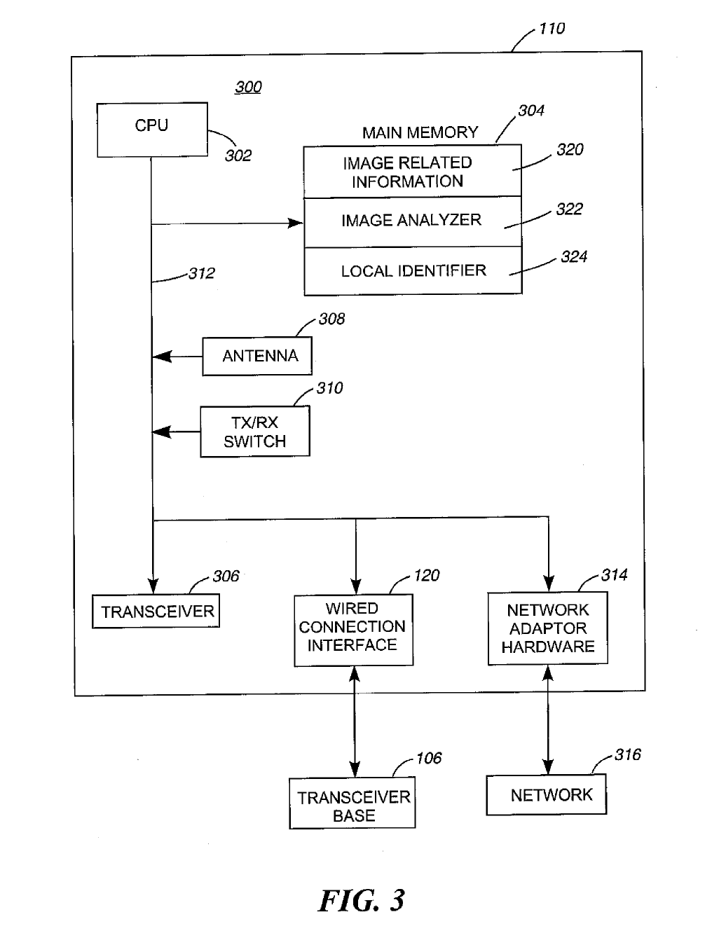

FIG. 3 illustrates an exemplary pointing device 110. The pointing device base 110, in one embodiment, is communicatively coupled to the information processing system 106 and wirelessly communicates with the pointing device 108. The pointing device base 110, in one embodiment, includes a processor 302 that is connected to a main memory 304, antenna 308, transmit/receive switch 310, transceiver 306, wired connection interface 316, an optional network adapter hardware 314. A system bus 314 interconnects these system components.

The main memory 304 comprises captured image related information 320 that has been received from the pointing device 108. The captured image related information 320, in one embodiment, can be the entire image frame 220 captured by the pointing device 108, a portion of the captured image frame 220, or coordinates within the captured picture frame, and the like. The main memory 304 also includes, in one embodiment, an optional image analyzer 322 for analyzing the captured image related information 320 received from the pointing device 108. As discussed above, the pointing device 108 can perform all or some of the image processing functions for determining where it is pointing to in a generated image.

If the pointing device does not perform enough processing on the captured image frame 120 so that a location within the displayed image 104 can be identified corresponding to where the pointing device 108 is pointing to, the transceiver base 110 can perform the required processing. An optional location identifier 324 in conjunction with the image analyzer 322 determines a location in the displayed image 104 that corresponds to a location within the captured image frame 120. In other words, the base station 110 can determine, based on the captured image related information 320, where the pointing device 108 is pointing to in the displayed image 104.

As discussed above, the displayed image can include various reference points or indices that are detectable by the image analyzer 322. Based on these reference points, the transceiver base 110 can communicate with the information processing system 106 for determining the pointed-to-location of the pointing device 108. In one embodiment, the image analyzer 322 can locate the four corners within the captured image 320 and perform linear interpolation to estimate the center of the camera's field of view relative to the captured image frame 120. The transceiver base 110 can then communicate this information to the information processing system 106 to the information processing system 106. The pointing device 108 or the information processing system 106 can similarly perform this linear interpolation procedure. It should be noted that although illustrated as concurrently resident in the main memory 304, it is clear that respective components of the main memory 304 are not required to be completely resident in the main memory 304 at all times or even at the same time.

As discussed above the pointing device 108 and the information processing system 106 can communicate with each other via the transceiver base 110. The transceiver base 110 includes a wired connection interface 120 such as USB, IEEE 1394, and the like for communicating with the information processing system 106. In another embodiment, the wired connection interface 120 allows the transceiver base 110 to be connected to other devices such as a gaming console. This allows for the pointing device 108 to be used as a peripheral for the gaming console.

The base 110 also includes an antenna 308, transmit/receive switch 310, and a transceiver 306 for communicating with the pointing device 108. In a receive mode, the antenna 308 is electrically coupled through the transmit/receive switch 310 to the transceiver 306 (or a separate receiver). The transceiver 306 decodes the received signals and provides those decoded signals to the processor 302. In a transmit mode, the antenna 308 is electrically coupled through the transmit/receive switch 310, to the transceiver 306 (or a separate transmitter). The processor 302, in one embodiment, operates the transceiver 306 according to instructions (not shown) in the main memory 304. Any wireless communication standard may be used by the transceiver base 110 to communicate with the pointing device 108. For example, the transceiver base 110 can be a Bluetooth device or capable of using a high speed wireless communication standard. The transceiver base 110, in one embodiment, also includes network adapter hardware 314 for connecting to a network 316. For example, the transceiver base 110 can communicate with the information processing system 106 or the pointing device 108 through a network 316, which can be either wired or wireless.

Exemplary Information Processing System

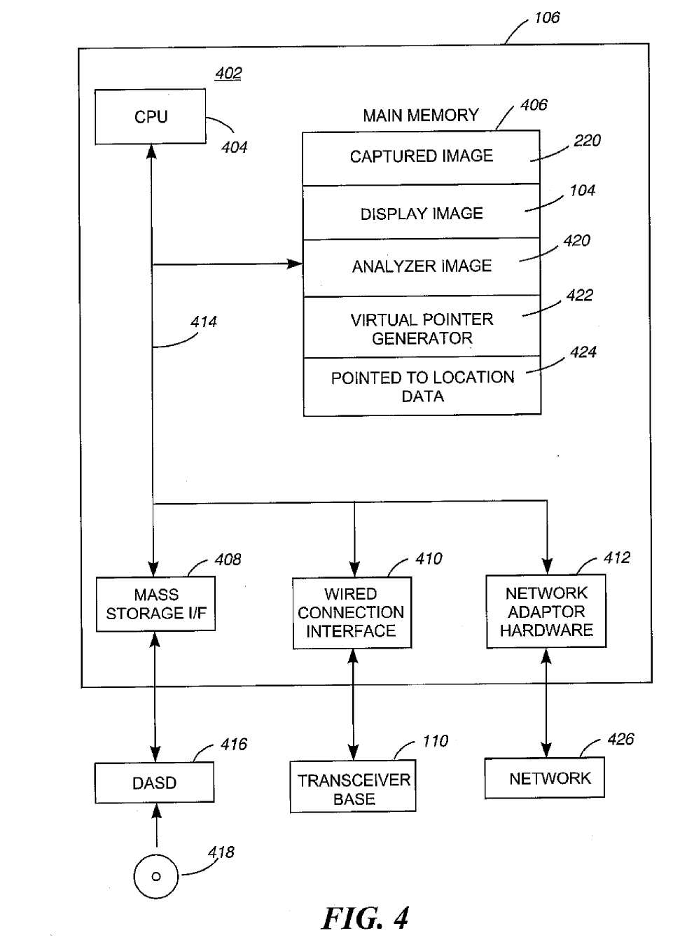

FIG. 4 is a block diagram illustrating a more detailed view of the information processing system 106 of FIG. 1. The information processing system 106 is based upon a suitably configured processing system adapted to implement the exemplary embodiment of the present invention. Any suitably configured processing system is similarly able to be used as the information processing system 106 by embodiments of the present invention, for example, a personal computer, workstation, gaming console, or the like. The information processing system 106 includes a computer 402. The computer 402 includes a processor 404 that is connected to the main memory 406, mass storage interface 408, wired connection interface 410, and network adapter hardware 412 via the system bus 414. The mass storage interface 408 is used to connect mass storage devices such as data storage device 416 to the information processing system 106. One specific type of data storage device is a computer readable medium such as a CD drive or DVD drive, which may be used to store data to and read data from a CD 418 (or DVD). Another type of data storage device is a data storage device configured to support, for example, NTFS type file system operations.

The main memory 406, in one embodiment, includes the captured image frame(s) 220 or at least the captured related information. For example, the captured image frame(s) 220 can be fully processed or partially processed by the pointing device 108 and/or the transceiver base 110. Therefore, the processing system 106 can receive information related to the captured image to perform further processing. The transceiver base 110, in one embodiment, may not include any processing functions and can act as a communication channel between the pointing device 108 and the information processing system 106. In another embodiment, the captured image frame(s) 220 may not have been processed at all, so the entire image is received by the information processing system 106.

The main memory 406, in one embodiment, also includes an image to be displayed 104. The display image 104 is an image or set of images that is generated by the information processing system 106 and displayed in a display area 122. In another embodiment, the information processing system 106 receives an image to be displayed from an external source such as a DVD player, VCR, and the like. In another embodiment, the main memory 406 also includes pointed-to-location data 424 that is received from either the pointing device 108 and/or the transceiver base 110. If the pointing device 108 and/or the transceiver base 110 process the captured image 220 and determines the location of where the device 108 is pointing to in the displayed image 104, they can transmit this data to the information processing system 106.

The information processing system 106, in one embodiment, uses this information to generate a virtual pointer 102 using a virtual pointer generator 422. However, if pointed-to-location data 424 is not received, the information processing system 106 uses an image analyzer 420 to analyze the captured image 220. The processing system 106 can determine the location in the display image 104 that the pointer 108 is pointing to using the methods discussed abode. Once the location is determined, the virtual pointer generator 422 can display a virtual pointer 102 at the location. It should be noted that the present invention is not limited to generating a virtual pointer 102. The determined pointed-to-location can be used to allow a user to interact with the displayed image 104. For example, the user can use the pointing device 108 to move items on the screen, aim, and perform other functions.

Although only one CPU 404 is illustrated for computer 402 computer systems with multiple CPUs can be used equally effectively. Embodiments of the present invention further incorporate interfaces that each includes separate, fully programmed microprocessors that are used to off-load processing from the CPU 404. The wired connection interface 410 is used to directly connect the information processing system 106 with the transceiver base 1102. The wired connection 410 can also be used to connect one or more terminals to the information processing system 106 for providing a user interface to the computer 402. These terminals, which are able to be non-intelligent or fully programmable workstations, are used to allow system administrators and users to communicate with the information processing system 106. A terminal is also able to consist of user interface and peripheral devices that are connected to computer 402 and controlled by wired connection interface hardware included in the wired connection I/F 410 that includes video adapters and interfaces for keyboards, pointing devices, and the like.

An operating system (not shown) included in the main memory 406 is a suitable multitasking operating system such as the Linux, UNIX, Windows XP, and Windows Server 2003 operating system. Embodiments of the present invention are able to use any other suitable operating system. Some embodiments of the present invention utilize architectures, such as an object oriented framework mechanism, that allows instructions of the components of operating system (not shown) to be executed on any processor located within the information processing system 106. The network adapter hardware 412 is used to provide an interface to a network 426 such as a wireless network, WLAN, LAN, or the like. Embodiments of the present invention are able to be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via a CD/DVD, e.g. CD 418, or other form of recordable media, or via any type of electronic transmission mechanism.

An Example of Displaying a Virtual Pointer on a Displayed Image

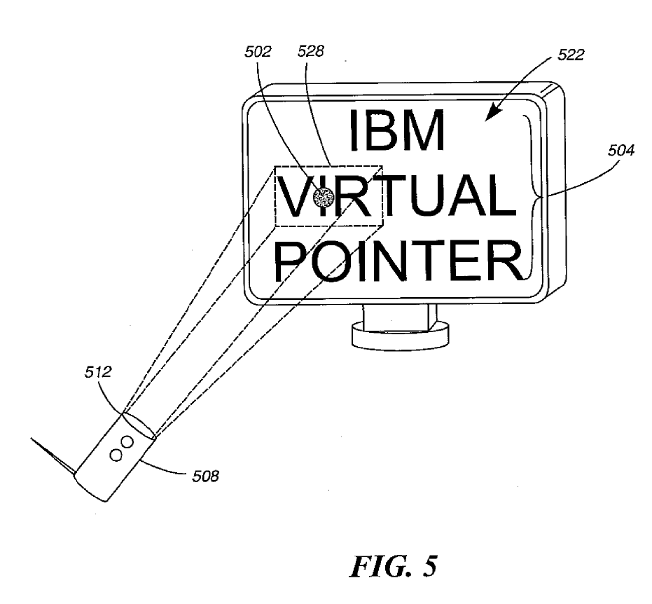

FIGS. 5-8 show an example of displaying a graphical pointer 502 on a displayed image 504 corresponding to where a pointing device 108 is pointing to. FIG. 5 shows the displayed image 504 in the display area 522. As the pointing device 508 is pointed at the display area 522 the camera 512 within the pointing device 508 captures image frames. The captured image frames correspond to where the pointing device 508 is pointing to.

For example, the camera 512 has a field of view 528 and the captured images correspond to this field of view 528. The field of view 528, in one embodiment, can capture the entire display area 522 and therefore the entire displayed image 504 or the field of view 528 may only capture a portion of the displayed image 504 as shown in FIG. 5. Based on the location in the displayed image 504 or display area 522 being pointed to by the pointing device 508, the information processing system 106 generates a virtual pointer 502 at the pointed to location in the displayed image.

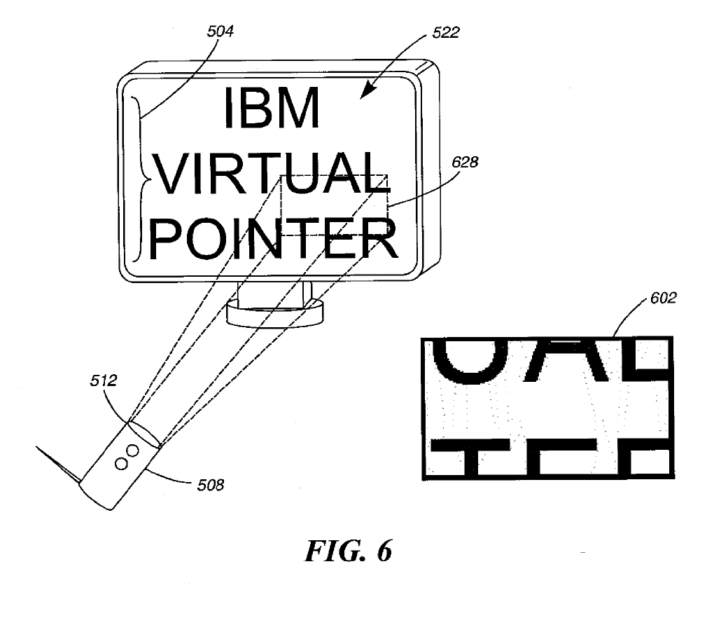

FIG. 6 shows the pointing device 508 pointing at a new location in the display area 522. As the field of view 528 of the camera 512 changes (i.e. the pointer is moving), new image frames are captured by the camera 512. As can be seen, the field of view 628 for the camera 512 in FIG. 6 has changed from FIG. 5. FIG. 6 also shows the image frame 602 captured by the camera 512 for that particular field of view 628. The image frame 602 includes a portion of the displayed imaged 504 currently being pointed to by the pointing device 508. It should be noted that as the pointing device 508 moved from the position shown in FIG. 5 to the location of the displayed image 504 shown in FIG. 6, image frames were captured along the way to track the movement of the pointing device 508. Also, FIG. 6 shows one embodiment where the field of view 628 encompasses only a portion of the displayed image 504. As discussed above, the field of view 628 in another embodiment can encompass the entire displayed image 504 or display area 522.

Also as discussed above, the captured image frame 602 is used by either the pointing device 508, transceiver base 110 (if included in the system 100) and the information processing system 106 to determine the location in the displayed image 504 that the pointing device 508 is pointing to. In one embodiment, the displayed image 504 includes reference points and/or indices that are detectable by the image analyzer of the devices. The information processing system 106 knows the locations of these reference points within the displayed image 504. The information processing system 106 transmits information associated with reference points detected within the field of view 628 of the camera by the pointing device 504 or base. Based on the received information associated with the detected reference points the information processing system 106 can determine where the pointing device 508 is pointing to. In one embodiment, the camera 512 searches for the reference point closest to a center point, e.g., a center pixel of the field of view 628. This allows for a virtual pointer 502 to be placed substantially close to the center of where the pointing device 508 is pointing.

In another embodiment, the pointed-to-location of the pointing device 508 is determined using a linear estimate. The linear estimate, in one embodiment, is based on the distance of the camera center pixel to the edges of the captured image frame 602. The relative lengths of the edges could allow for a first order location estimation that incorporates a length scale distortion that accompanies the angle and position induced shape distortion. For example, the pointing device 508 is not always going to be at a perpendicular plane with the displayed area. For example, the pointing device can be viewing the displayed image 504 an angle. A virtual pointer 502 can then be displayed at this first order location estimation. If the virtual pointer 508 is not detected by the pointing device 508, it can communicate this to the information processing system 106, which would display the virtual pointer at another position until the pointing device 508 notifies the information processing system 106 that the virtual pointer 502 has been detected. In an embodiment in which the entire display area 522 is captured, the virtual pointer 502 should always be detected (when displayed) within the captured frame 602.

In another embodiment, the information processions system 106 communicates with the pointing device 508 to notify the pointer that the virtual pointer 502 has been displayed. Additionally, when the virtual pointer is placed within the field of view of 628 of the camera, whichever device or combination of devices are analyzing the captured image frames 602 can notify the information processing system 106 of the virtual pointer's 502 position with respect to the center pixel area of the camera's field of view 628. If the virtual pointer 502 is not within the center area, this information can be communicated to the information processing system 106 for the proper adjustments. For example, a closed loop error function that is scaled by the overall size of the image 504 can be used to correct the position of the virtual pointer 502.

Another method for determining the location in a displayed image 504 where the pointing device 508 is aimed at utilizes transformations. A transformation can be created that maps points from the image captured 602 by the pointing device 508 to points in the displayed image 504 on the display area 522. For example, a projective transformation P¢ between the image 602 captured by the camera 512 and displayed image 504 in the display area 522 can be defined. In one embodiment, this transformation can be determined automatically by extracting the camera image 602 coordinates of the corners, cᵢ=[cᵢ^{x}cᵢ^{y}1], i=1, 2, 3, 4. Assuming the coordinates of the pattern corners to be identical to the mesh M in application space, bᵢ=[bᵢ^{x}bᵢ^{y}1], i=1, 2, 3, 4, P′C=B can be obtained, and computing the pseudo-inverse yields P′=BC^{T}(CC^{T})⁻¹. To complete the computation of the transformation H, the correspondence between the displayed image and the camera image planes is determined. This can be done, in one embodiment, by projecting a pattern with four non-colinear points rendered on the image plane of the displayed image 504 dᵢ=[dᵢ^{x}dᵢ^{y}1], i=1, 2, 3, 4 and obtaining four points on the projected surface, eᵢ=[eᵢ^{x}eᵢ^{y}1], i=1, 2, 3, 4. Then by image processing the image of the pattern, it is possible to determine the coordinates of its four corners on the captured image plane, fᵢ=[fᵢ^{x}fᵢ^{y}1], i=1, 2, 3, 4. Because E=[e₁^{T}e₂^{T}e₃^{T}e₄^{T}1]corresponds both to the projection of D=[d₁^{T}d₂^{T}d₃^{T}d₄^{T}] by the displayed image, PD=E, and to the captured image of the pattern, P′F=E, PD=P′F is obtained. Computing the pseudo-inverse, P=P′FD^{T}(DD^{T})⁻¹ and therefore H=DD^{T}(P′FD^{T})⁻¹. In one embodiment, this transformation is implemented by computing a warped mesh M′=KHM.

In other words, if four or more points, e.g. x-y coordinates, are known in the displayed image 5004 a transformation can be created. For example, four or more points such as the corners of the displayed image 504 are known to the information processing system. The pointing device 508, transceiver base 110, or information processing system 106 can determine where these four known points are within the captured image 602. A transformation can then be created that maps these points from the captured image 602 to the displayed image 504 thereby determining where the pointing device 508 is pointing to within the displayed image 504.

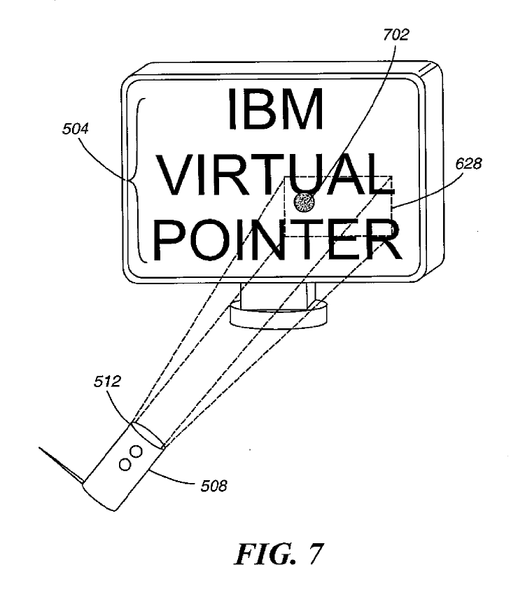

Once the information processing system 106 identifies where the pointing device 2008 is pointing at in the displayed image 504 it can then display a virtual pointer 702 at that location as shown in FIG. 7. FIG. 7 shows an example where the information processing system 106 generated the virtual pointer 702 at an off-center location within the field of view 628 of the pointing device 508. It should be noted that the virtual pointer 702 is not limited to a circular dot. For example, the virtual pointer 702 can be a cursor, an icon, and the like that is animated, comprises various colors, is of any shape, size, color, pattern, or the like. Also, the virtual pointer 702 does not need to be displayed. For example, the pointed-to-location can be used for aiming functions such as in a video game or controlling movement of a widget or character.

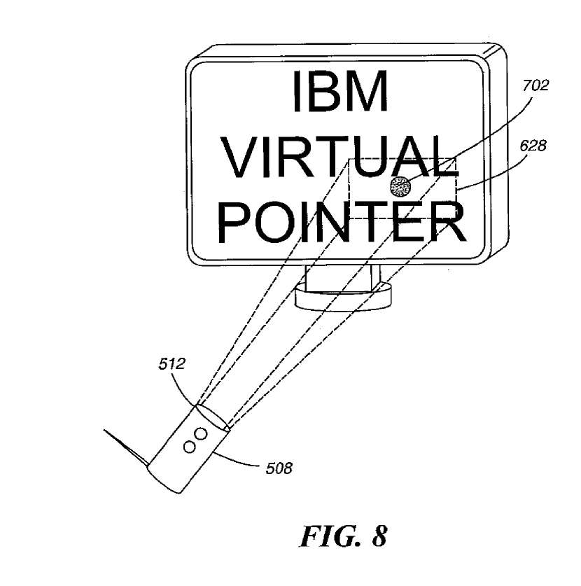

The virtual pointer 702, in one embodiment, can be of a predetermined color, size and/or shape. Alternatively, the virtual pointer 702 can be dynamically chosen based on display color, program functions, and the like. The information processing system 106 can also communicate characteristics associated with the virtual pointer 702 to the pointing device 508. Once the pointing device 508 detects the virtual pointer 702, the pointing device 508 can communicate the location of the virtual pointer 702 within its field of view 628 to information processing system 106. For example, if the virtual pointer is off center from the camera's field of view 628 as shown in FIG. 7, this can be communicated to the information processing system 106. The information processing system can then adjust the location of the virtual pointer 702 so that it is centered within the field of view 628 as shown in FIG. 8.

Note that the virtual pointer 802 can be generated continuously, only when a button on the pointer is pressed on the pointing device 508, or only at certain computed times. 702.

Exemplary Process for Displaying a Virtual Pointer in a Displayed Image

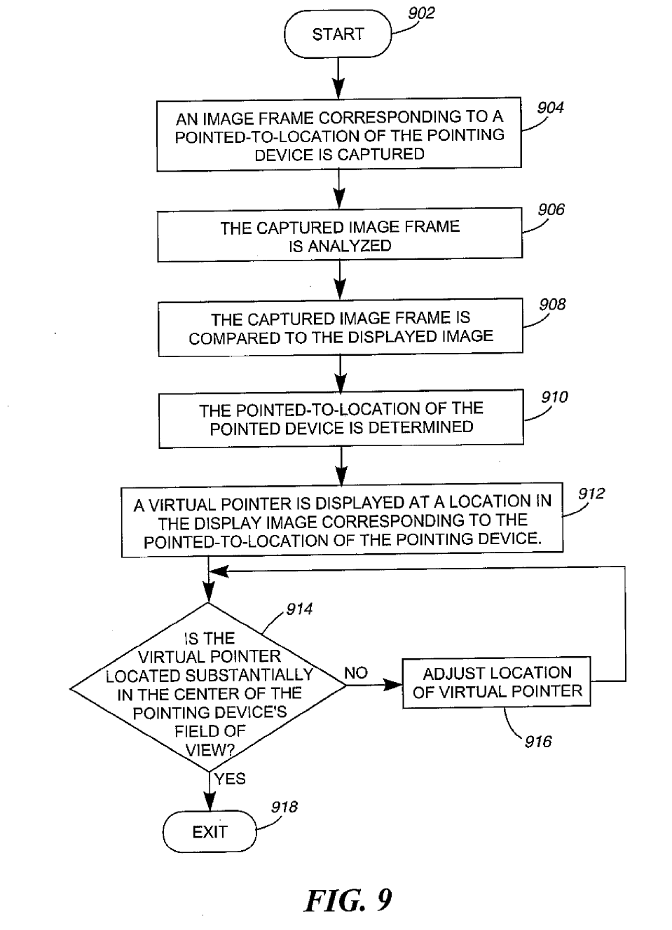

FIG. 9 shows an exemplary process of. The operational flow diagram of FIG. 9 begins at step 902 and flows directly to step 904. The pointing device 108, at step 904, captures one or more image frames corresponding to a current location within a displayed image that the device 108 is pointing to. The captured image frame(s) 220, at step 906, are then analyzed. As discussed above, the pointing device 108 can analyze all, part, or none of the captured image frame 220 itself. The results from the analysis, or alternatively the entire image or partially processed image, can be transmitted to the transceiver base 110 or the information processing system 106. The transceiver base 110 and the information processing system 106 can also perform the analyzing.

The captured image frame 220, at step 908, is compared to the displayed image 104. As discussed above, the displayed image can include reference points or indices. If the corners of the displayed image area are intended to be the indices, no specific comparison with the particular displayed image 104 is required. The corners of the display provide, for example, the necessary 4 reference points for an image transformation approach. The captured image frame 220 is compared to the displayed image 104 for determining the location within the displayed image 104 that the pointing device 108 is pointing to. Also as discussed above, a more complicated method of image transformations can be used to determine the point-to-location. The pointed-to-location of the pointing device, at step 910, is then determined by the pointing device 108, the transceiver base 110, or the information processing system utilizing the methods discussed above.

The information processing system 106, at step 912, displays a virtual pointer 102 at a location within the displayed image 104 that corresponds to the pointer-to-location of the pointing device 108. The information processing system 106, at step 914, determines whether the virtual pointer 102 is in the center of the pointing device's field of view. For example, based on information received from the pointing device 108, the information processing system can determine if the virtual pointer is in the center of the devices field of view. Alternatively, the pointing device 108 can detect if the virtual pointer 102 is in the center of its field of view.

If the result of this determination is negative, the information processing system 106, at step 916, adjusts the location of the virtual pointer 102. The determining and adjusting process continues until the virtual pointer 102 is located substantially within the center of the pointing device's field of view. If the result of the above determination is positive (i.e. the virtual pointer 102 is substantially in the center) the control flow exits at step 918. The correction required to center the pointer may be retained for use in subsequent pointer location display computations.

Non-Limiting Examples

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for displaying a graphical pointer at a location on a display area, the method comprising:
displaying, with an information processing system, a display image at a display area;
capturing, by a pointing device, an image corresponding to at least a portion of the display image at the display area in a field of view of the pointing device; and
determining a location within the display image corresponding to a location in the at least the portion of the display image in the field of view of the pointing device.

2. The method of claim 1, further comprising:
displaying, with the information processing system and based on the determining, a virtual pointer at the determined location within the display image corresponding to a location in the at least the portion of the display image in the field of view of the pointing device, wherein the location of the displayed graphical pointer in the displayed image is based at least in part on information related to the captured image.

3. The method of claim 1, further comprising:
transmitting, by the pointing device, captured image related information to the information processing system that is causing the display image to be displayed at the display area.

4. The method of claim 3, wherein the transmitting by the pointing device further comprises:
transmitting the captured related information to the information processing system via a transceiver base.

5. The method of claim 1, wherein the displaying further comprises:
determining if the location of the virtual pointer is at a location in the display image that is substantially in the center of the field of view of the pointing device; and
adjusting the location of the virtual pointer, in response to determining that the location of the virtual pointer failed to be substantially in the center of the field of view of the pointing device, to be substantially in the center of the field of view of the pointing device.

6. The method of claim 1, wherein the information related to the captured image comprises one of:
the image captured by the pointing device; and
information associated with a location within the image captured by the pointing device that the pointing device is pointing to.

7. The method of claim 1, wherein the determining further comprises:
identifying a set of reference points within the image captured by the pointing device;
comparing the set of reference points in the image captured by the pointing device to a set of reference points in the display image; and
identifying, based on the comparing, a set of reference points in the display image that matches the set of reference points in the image captured by the pointing device.

8. The method of claim 1, wherein the determining further comprises:
calculating a transformation function based on the image captured by the pointing device and the display image.

9. A method, with a pointing device, for displaying a graphical pointer at a location on a display area, the method comprising:
capturing an image corresponding to at least a portion of a displayed image at a display area in a field of view of the pointing device;
analyzing the captured image;
identifying, based on the analyzing, a location in the captured image corresponding to a location in the displayed image at the display area; and
transmitting information associated with the identified location to an information processing system that is causing the displayed image to be displayed at the display area.

10. A method, with an information processing system, for displaying a graphical pointer at a location on a display area, the method comprising:
generating a display image;
displaying the display image in a display area, receiving captured image related information from a pointing device, wherein the captured image related information is associated with an image captured by the pointing device that corresponds to at least a portion of the display image at the display area in a field of view of the pointing device; and
determining, based on the received captured image related information, a location in the display image at the display area corresponding to a location in the at least the portion of the display image at the display area in the field of view of the pointing device.

11. The method of claim 10 further comprising:
displaying, based on the determining, a virtual pointer at the determined location in the display image at the display area.

12. A display pointing system comprising:
an information processing system;
a display, communicatively coupled with the information processing system, operable for displaying a display image at a display area of the display;
a pointing device, communicatively coupled with the information processing system, operable for capturing, by the pointing device, an image corresponding to at least a portion of the display image at the display area in a field of view of the pointing device; and
wherein the information processing system is operable for determining a location within the display image corresponding to a location in the at least the portion of the display image in the field of view of the pointing device.

13. The display pointing system of claim 12, wherein the information processing system, based on the determined location within the display image, is operable to cause a virtual pointer to be displayed at the determined location within the display image corresponding to a location in the at least the portion of the display image in the field of view of the pointing device, wherein the location of the displayed graphical pointer in the displayed image is based at least in part on information related to the captured image.

14. The display pointing system of claim 12, wherein the pointing device is communicatively coupled with the information processing system via wireless communication, and wherein the pointing device is operable to wirelessly transmit information related to the captured image to the information processing system which is causing the display image to be displayed at the display area of the display.

15. The display pointing system of claim 14, wherein the information related to the captured image comprises at least one of:
the image captured by the pointing device; and
information associated with a location, within the image captured by the pointing device, to which the pointing device is pointing.

16. A display pointing device comprising:
a processor;
image capturing means, communicatively coupled with the processor, operable for capturing an image corresponding to at least a portion of a displayed image at a display area in a field of view of the pointing device; and
a transmitter, communicatively coupled with the processor, operable for transmitting information to an information processing system that is causing the displayed image to be displayed at the display area, and wherein the processor is further operable for:
analyzing the captured image,
identifying, based on the analyzing, a location in the captured image corresponding to a location in the displayed image at the display area; and
transmitting, with the transmitter, information associated with the identified location to the information processing system that is causing the displayed image to be displayed at the display area.
